(19) United States
(12) Patent Application Publication
(10) Pub. No.: US 2011/0291918 A1
(43) Pub. Date: Dec. 1, 2011

(54) Enhancing Vision Using An Array Of Sensor Modules

(75) Inventors: Dan C. Surber, Zionsville, IN (US); Marion P. Hensley, Pendleton, IN (US)

(73) Assignee: RAYTHEON COMPANY, WALTHAM, MA (US)

(21) Appl. No.: 12/791,119

(22) Filed: Jun. 1, 2010

(51) Int. Cl. H04N 7/18; B60Q 1/00; G09G 5/00

(52) U.S. Cl. 345/8; 348/148; 340/425.5; 348/E07.085

(57) ABSTRACT

According to one embodiment, a method for enhancing vision for a vehicle includes recording external surroundings of the vehicle by a sensor array comprising a plurality of sensor modules including at least two different types of sensor modules, such that the sensor array is coupled to the exterior of the vehicle. The method further includes determining a field of view and one or more types of sensor modules to be displayed. The method further includes displaying the recorded external surroundings of the vehicle associated with the determined one or more types of sensor modules associated with the field of view to be displayed.

### TECHNICAL FIELD

This invention relates generally to the field of sensors and more specifically to enhancing vision using an array of sensor modules.

### BACKGROUND

It is difficult for operators of vehicles, such as tanks, to view the external surroundings around all sides of the vehicle. For example, operators of tanks may only be able to see what is directly in front of the tank or a limited “soda straw” view that follows the same line of sight as the gun barrel of the tank. Further, the vehicle may have several different sensors attached with moving gimbals having separate controls. Each sensor attached to a separate moving gimbal may provide the operators of vehicles with different vision information. However, it is impractical for an operator of the vehicle to obtain numerous views around all sides of the vehicle by using numerous controls to control the numerous moving gimbals for each sensor.

### SUMMARY OF THE DISCLOSURE

According to one embodiment, a method for enhancing vision for a vehicle includes recording external surroundings of the vehicle by a sensor array comprising a plurality of sensor modules including at least two different types of sensor modules, such that the sensor array is coupled to the exterior of the vehicle. The method further includes determining a field of view and one or more types of sensor modules to be displayed. The method further includes displaying the recorded external surroundings of the vehicle associated with the determined one or more types of sensor modules associated with the field of view to be displayed.

According to some embodiments, the recorded external surroundings are displayed by a helmet display configured to be worn by an operator of the vehicle, such that the field of view to be displayed is substantially identical to a field of view of an operator of the vehicle.

According to some embodiments, the method further includes combining the recordings from a plurality of different types of sensor modules, and displaying the combined recorded external surroundings from the plurality of different types of sensor modules associated with the field of view to be displayed.

Certain embodiments of the invention may provide one or more technical advantages. A technical advantage of one embodiment may include providing multi-faceted and multi-spectral vision. A further technical advantage of one embodiment of the present disclosure may include a single controller, such that operators of system do not have to use a plurality of controllers to individually control separate sensors.

Further technical advantages of particular embodiments of the present disclosure may include an enhanced vision system that is lighter weight than conventional sensor systems. Yet another technical advantage of one embodiment may be a relatively low cost solution for providing a customizable array of module sensors for a vehicle or structure.

Various embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates an enhanced vision system for a vehicle, in accordance with one example embodiment;

FIG. 2 illustrates a more detailed view of an array of sensor modules, according to one example embodiment; and

FIG. 3 provides a flow chart illustrating an example method for using an array of sensor modules, according to one example embodiment.

### DETAILED DESCRIPTION OF THE DISCLOSURE

It should be understood at the outset that, although example implementations of embodiments of the invention are illustrated below, the present invention may be implemented using any number of techniques, whether currently known or not. The present invention should in no way be limited to the example implementations, drawings, and techniques illustrated below. Additionally, the drawings are not necessarily drawn to scale.

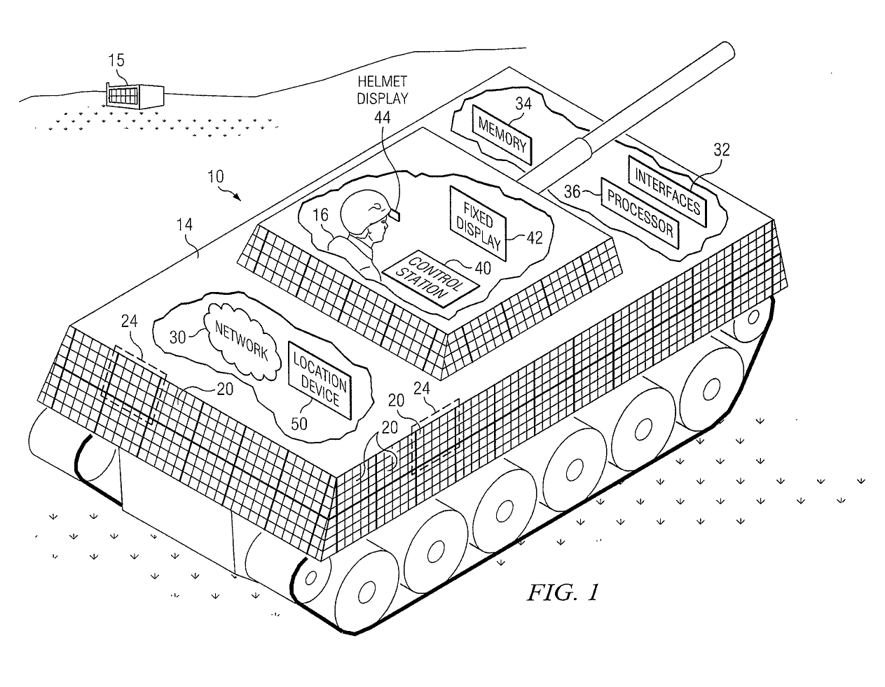

FIG. 1 illustrates an enhanced vision system 10 for a vehicle 14, in accordance with one example embodiment. Enhanced vision system 10 may include one or more vehicles 14, one or more sensor modules 20, one or more arrays 24 comprising one or more sensor modules 20, a network 30, one or more interfaces 32, one or more control stations 40, one or more fixed displays 42, one or more helmet displays 44, and one or more location devices 50. Vehicles 14 may include one or more operators 16. In some embodiments, elements of enhanced vision system 10 may be used with structures 15 in addition to vehicles 14. In general, enhanced vision system 10 is operable to display a multifaceted and multispectral display of the external surroundings of vehicle 14 or structure 15.

A field of view may be defined as the range of everything capable of being observed by a particular object—be it a person or sensing device. For example, a field of view of a person may be the range of everything that a person may observe in a particular line of sight, including peripheral vision. A field of view of a sensing device such an antenna may be every direction the antenna is capable of detecting an electromagnetic signal. Surroundings are generally one or more persons, places, objects, or things capable of being observed. For example, surroundings may be a vehicle and a wall observed by infrared sensors by infrared light radiating from these objects. Additionally, surroundings may be radiation such as electromagnetic radiation.

Vehicle 14 may be any machine that is operable to move. Non-limiting examples of vehicles 14 may include a tank, truck, car, sea-going vessel, or aircraft.

In some embodiments, enhanced vision system 10 may be used with structures 15 in addition to vehicles 14. Structures 15 may be any object. Non-limiting examples of structures 15 may include a building, wall, or pole.

Operator 16 may be any person or machine operable to control vehicle 14 and/or elements of vehicle 14. For example, operator 16 may be part of the crew of vehicle 14. In some embodiments, operator 16 may be remote from vehicle 14, such that vehicle 14 may be unmanned. In some embodiments, operator 16 may drive vehicle 14 and/or fire weapons from vehicle 14. In some embodiments, operator 16 may remotely monitor the area within view of structure 15 coupled to sensor modules 20.

Sensor modules 20 may be operable to measure and store information associated with the external surroundings of vehicle 14 in memory 34. Sensor modules 20 may comprise appropriate hardware and/or software to observe and record images or other information of the external surroundings of vehicle 14. Non-limiting examples of sensor modules 20 may include a device operable to observe and record data, such as but not limited to a charge coupled device (CCD) camera, an electro-optical (EO) sensor, an infrared radiation (IR) sensor, a radio frequency (RF) sensor, a laser sensor, etc. Non-limiting examples of CCD cameras may include digital cameras operable to record digital, color images. Non-limiting examples of EO sensors may include sensors operable to convert light rays to electronic signals, such that EO sensors may increase both the range and ability to see at low ambient light levels (e.g., seeing with the same clarity and range at night as during the day). Non-limiting examples of IR sensors may include short, mid, or long wave IR sensors operable to measure IR energy radiating from objects. IR sensors may also be used as motion sensors to detect when an IR source with one temperature (e.g., a person) passes in front of another IR source with another temperature (e.g., a wall). Non-limiting examples of RF sensors may include radar using radio frequencies to determine the distance of objects to the RF sensors (e.g., ultra-wide band or millimeter wave). Non-limiting examples of laser sensors may include a solid state laser range finder combined with a pulsed designator that is operable to determine the distance from the laser to objects within its field of view and mark a particular object. For example, marking a particular object may be useful to fire weapons accurately at that particular object. In some embodiments, the laser may be invisible to the human eye. In some embodiments, ultra-wide band and laser types of sensor modules 20 may identify objects, determine range of objects from vehicle 14, and/or geophysical location data of objects based on data from location device 50. In particular embodiments, laser sensor modules 20 may be steerable, such that the laser beam may be pointed within a limited field of regard within the array's 24 field of regard where laser module 20 is located. Use of several other sensor modules 20 not expressly described herein are also contemplated and the present disclosure is not limited in any way to the examples listed.

In some embodiments, sensor module 20 may include one or more types of sensors integrated into a single sensor module 20. For example, an IR sensor and an RF sensor may be combined into an IR/RF sensor module 20 having the same size as other sensor modules 20. Any number of combination of sensor types are also contemplated and the present disclosure is not limited in any way to the examples of combination of sensor types listed.

In some embodiments, a type of sensor module 20 may be categorized as active or passive. A passive type of sensor module 20 may be defined as a sensor type that can not be easily detected (e.g., low RF waves). An active type of sensor module may be defined as a sensor type 20 that can be easily detected (e.g., lasers and ultra-wide band RF). In some embodiments, a passive type of sensor module 20 may always record the digital data of the surroundings within its field of view. In some embodiments, an active type of sensor module 20 may only be used when instructed by operator 16 or processor 36. In some embodiments, an active type of sensor module 20 may be used to identify and communicate with vehicles 14 of allies, which may be referred to as “blue force” identification. In some embodiments, “blue force” identification and communication may provide a low probability of intercept and detection relative to voice communications. Thus, in particular embodiments, enhanced vision system 10 provides operator 16 with a lot of tactical flexibility.

In some embodiments, each sensor module 20 may have substantially the same height, length, and width. In some embodiments, the external side of sensor modules 20 may include a material, such that the material may be bullet proof, transparent to radio frequencies, and/or optically transmissive. In some embodiments, this material may be transparent aluminum armor, including, but not limited to aluminum oxynitride (ALON).

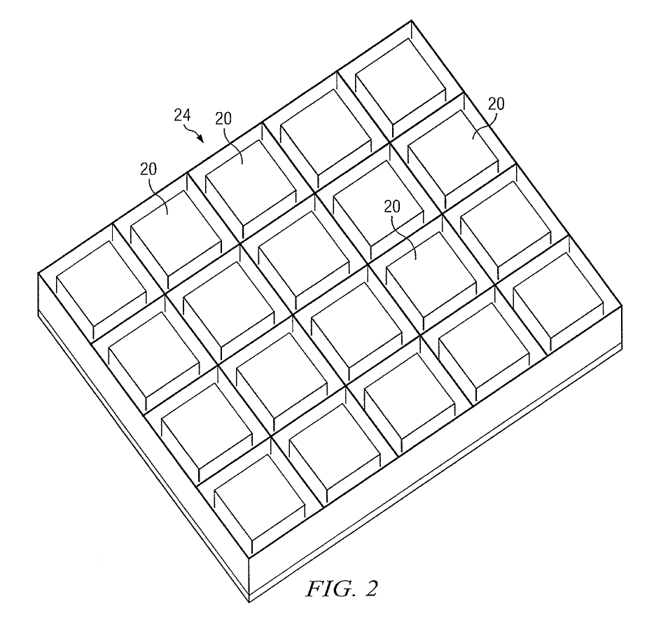

Array 24 of sensor modules 20 may include a plurality of sensor modules 20 as described below in more detail in FIG. 2. Array 24 may include a predetermined number of sockets having substantially the same depth, length, and width as sensor modules 20. Array 24 having a higher density of sensor modules 20 may be detected easier, but may be better for targeting objects. Array having a lower density of sensor modules 20 may be harder to detect, but it may be harder to target objects. In some embodiments, array 24 may be an un-cooled staring focal plane array. In some embodiments, high, medium, or low density staring focal plane arrays 24 may be used depending upon the degree of resolution desired.

In particular embodiments, sensor modules 20 may be easily installed and removed from array 24 because each sensor module 20 may be designed to plug and play with array 24. In some embodiments, sensor modules 20 of one type may be easily replaced with sensor modules 20 of another type. Thus, enhanced vision system 10 may provide a simple, inexpensive customizable and modular solution for installing arrays 24 of sensor modules 20, as desired for particular situations. Previous solutions for installing a customized array of sensors were expensive and complicated because each combination of sensors had to be separately built into one device and installed into its own port with its own controller.

Enhanced vision system 10 may provide a practicable solution for customizing an array 24 of sensor modules 24 based on a particular mission. For example, module sensors 20 operating at five GHz may be desirable on sea to observe objects farther away, but module sensors 20 operating at two GHz may be desirable on land to observe objects within vegetation. If vehicle 14 is being transported from a desert environment to a jungle environment or the seasons change from a dry season to a rainy season, then enhanced vision system 10 may be configurable for operator 14 to simplistically and inexpensively customize the types of sensor modules 20 to best handle the environmental situation. Enhanced vision system 10 may provide the flexibility to operate in all weather conditions and all year round in any regional area.

Enhanced vision system 10 may provide operators 16 of vehicle 14 a greater chance of surviving and completing a mission because arrays 24 of sensor modules 20 provide a redundant number and type of sensor modules 20 that may be placed in a plurality of locations. For example, if an enemy damaged a section of vehicle 14 that included a portion of sensor modules 20, then enhanced vision system 10 may be able to use other sensor modules to properly display the external surroundings of vehicle 14, such that vehicle 14 and operators 16 may still achieve their objectives. However, a traditional solution may have only had one type of sensor or one array of sensor located at the same location, such that if that sensor or array was damaged by the enemy, operator 16 of vehicle 14 may not have been able to properly view the external surroundings of vehicle 14, which may reduce operator's 16 chance to properly defend the crew of vehicle 14 or to carry out their objective.

In some embodiments, an array 24 may be a staring array of sensor modules 20 and arrays 24 may be placed around perimeter of vehicles 14 or structures 15 with a slight overlap of their fields of regard. Sensor modules 20 in arrays 24 may observe and record a fixed line of sight that is orthogonal to the surface of vehicle 14 or structure 15. Sensor modules 20 may be operable to see a number of degrees off the referenced line of sight in any direction. Arrays 24 and sensor modules 20 may be placed on curved or straight surfaces. For example, if array is placed on a curved surface, each sensor module 20 may require a wider field of regard for its aperture than if array 24 is placed on a straight surface.

In some embodiments, the number, placement, and type of sensor modules 20 may vary. For example, FIG. 1 illustrates an exemplary enhanced vision system 10 comprising ten rows and numerous columns of sensor modules 20 coupled to the entire perimeter of the body of vehicle 14, and fives rows and numerous columns of sensor modules 20 coupled to the entire perimeter of the turret of vehicle 14, according to one example embodiment. FIG. 1 illustrates an example array 24 having four rows and five columns of module sensors 20. In some embodiments, an additional number or a fewer number of sensor modules 20 and/or arrays 24 may be coupled to vehicle 14 or structure 15. In some embodiments, sensor modules 20 and/or arrays 24 may be coupled to different locations on vehicle 14 or structure 15.

Network 30 represents communication equipment, including hardware and any appropriate controlling logic, for interconnecting elements in enhanced vision system 10. Thus network 30 may represent a gigabit Ethernet network, local area network (LAN), a metropolitan area network (MAN), a wide area network (WAN), and/or any other appropriate form of network. Furthermore, elements within network 30 may utilize circuit-switched, packet-based communication protocols and/or other communication protocols to provide for network communications. The elements within network 30 may be connected together via a plurality of fiber-optic cables, coaxial cables, twisted-pair lines, and/or other physical media for transferring communications signals. The elements within network 30 may also be connected together through wireless transmissions, including infrared transmissions, 802.11 protocol transmissions, laser line-of-sight transmissions, or any other wireless transmission method.

Interfaces 32 may receive input, send output, process the input and/or output, and/or perform other suitable operation for the elements in FIG. 1. Interfaces 32 may include any hardware and/or controlling logic used to communicate information to and from one or more elements illustrated in FIG. 1.

Memory 34 may store, either permanently or temporarily, data from sensor modules and other information for processing by processor. Memory 34 may comprise any form of volatile or non-volatile memory including, without limitation, a solid state memory, magnetic media, optical media, random access memory (RAM), dynamic random access memory (DRAM), flash memory, removable media, or any other suitable local or remote component, or combination of these devices. Memory 34 may store, among other things, the digital data representing the surroundings observed by sensor modules 20. In some embodiments, memory 34 may store software and/or code for execution by processor 36. In some embodiments, memory 34 may be stored in vehicle 14 or structure 15 and/or remote from vehicle 14 or structure 15. In some embodiments, enhanced vision system 10 may store tags (e.g., date stamp, time, location, etc.) in memory 34 to be identified with the recorded digital data.

Processor 36 may control the operation and administration of elements within enhanced vision system 10 by processing information received from interface 32 and memory 34. Processor 36 may include any hardware and/or controlling logic elements operable to control and process information. For example, processor 36 may include application-specific integrated circuits (ASICs), field-programmable gate arrays (FGPAs), digital signal processors (DSPs), and any other suitable specific or general purpose processors. In certain embodiments, processor 36 may comprise a single-board computer (SBC) that comprises the components of a computer on a single circuit board. Processor 36 may also include an advanced technology attachment (ATA) bus, a graphics controller, and multiple USB ports.

In some embodiments, processor 36 may know which sensor modules 20 are associated with each possible line of sight or field of view. Processor 36 may know the type of sensor for each sensor module 20, such that processor 36 may determine which sensor modules 20 to process for display based on the selected type of sensor to be displayed.

In some embodiments, processor 36 associated with each array 24 may perform initial processing and video conversion of data associated with sensor modules 20 installed in that particular array 24. In some embodiments, processors 36 may be associated with each sensor module 20.

In operation, processor 36 may retrieve data from memory and process the data in'a format for display. For example, processor 36 may receive a plurality of data types from memory 34 associated with different types of sensor modules 20 (e.g., video data, infrared measurements, etc.) and combine this different data into one image to be displayed. The data representing the combination of one or more types of data for a particular field of view may be preprocessed and buffered in memory 34, such that this combined image is available almost instantaneously upon request from fixed display 42 and/or helmet display 44. For example, a combined image may display the IR, EO, CCD camera, and RF data (or any other combination of sensor types) for the same field of view.

Several embodiments of the disclosure may include logic contained within a medium. The medium may include RAM, ROM, or disk drives. The medium may be non-transitory. In other embodiments, the logic may be contained within hardware configuration or a combination of software and hardware configurations. The logic may also be embedded within any other suitable medium without departing from the scope of the disclosure.

Control station 40 may control the field of view to be displayed and/or the type of sensor modules 20 to be displayed. Control station 40 may comprise appropriate hardware and/or software to allow operator 16 to control the field of view to be displayed and/or the type of sensor modules 20 to be displayed. Control station 40 may include any user output device such as a cathode ray tube (CRT) or liquid crystal display (LCD) for providing visual information to operator 16. Control station 40 may also include a slewing control, keyboard, mouse, console button, or other similar type user input device for providing input. In some embodiments, control station 40 may comprise a graphical user interface (GUI) with a touch-screen interface for operator 16 to provide input. If control station 40 or operator 16 selects a particular line of sight (e.g., line of sight of external weapon), then enhanced vision system 10 may automatically display the digital data associated with sensor modules 20 with the same line of sight. If control station 40 or operator 16 determine to only display one or more selected types of sensor modules 20, then enhanced vision system 10 may automatically display only the images associated with the selected types of sensor modules 20. In some embodiments, control station 40 may allow operator 16 to electronically zoom in or zoom out of the displayed image.

One or more fixed displays 42 may be located in one or more locations inside vehicle 42. Fixed displays 42 may be operable to display digital images of the external surroundings of the entire perimeter of vehicle 14. Fixed display 42 may comprise appropriate hardware and/or software to provide operator 16 with digital images of the external surroundings to be displayed. Digital images of the external surroundings may be displayed on one or more fixed displays 42 substantially instantaneous and in real-time because the digital images and other information are already processed by processor 36 and buffered in memory 34. For example, fixed display 42 may comprise a screen, which may display digital images of the external surroundings and control options to operator 16. Embodiments of screen may provide a digital display of the images provided by sensor modules 20 and processed by processor 36. In some embodiments, fixed display 42 may comprise a graphical user interface (GUI) with a touch-screen interface for operator 16 to control what is displayed. In some embodiments, fixed display 42 may include slewing control, keyboard, mouse, console button, or other similar type user input device for providing input. Fixed display 42 may display the field of view of the external surroundings determined by operator 16 of fixed display or by operator 16 of control station 40. In some embodiments, fixed display 42 may be associated with a targeted object or line of sight of a weapon. In some embodiments, fixed display 42 may be configurable to display the combined digital images of the field of view from multiple different types of sensor modules 20. In some embodiments fixed display 42 may be configurable to selectively display one or more types of other information gathered by sensor modules 20 associated with the field of view to be displayed.

As one non-limiting example of the above, an operator 16 may choose to view a video feed which is gathered by a particular set of sensor modules 20. Then, the operator may choose to pan the view, pulling a video feed that is being gathered by other sensor modules. Additionally, in conjunction with the video feed or as separate view, the operator 16 may choose to view thermal imaging that is gathered by yet other sensor modules 20. The switching of the view and the decision for what is going to displayed can be controlled by the operators. And, in particular embodiments, the information gathered can be continuous allowing near-instantaneous views of desired information.

One or more helmet displays 44 may be located in one or more locations inside vehicle 42. Helmet displays 44 may be operable to display digital images of the external surroundings of the entire perimeter of vehicle 14.

Helmet displays 44 may comprise appropriate hardware and/or software to provide operator 16 with digital images of the external surroundings to be displayed. Digital images of the external surroundings may be displayed on one or more helmet displays 44 substantially instantaneous and in real-time because the digital images are already processed by processor 36 and buffered in memory 34. Helmet display 44 may configured to be worn by operator 16 of vehicle 14. The field of view to be displayed in helmet display 44 may automatically change to align with a field of view of an operator of the vehicle, such that the fields of view are substantially identical. For example, helmet display 44 worn by operator 16 of vehicle 14 may allow operator to view the external surroundings of vehicle as if the walls of vehicle were substantially transparent. For example, helmet displays 44 may comprise a visor or eye-glasses, which may display digital images of the external surroundings and control options to operator 16. Embodiments of screen may provide a digital display of the images provided by sensor modules 20 and processed by processor 36. In some embodiments, helmet display 44 may comprise a graphical user interface (GUI) with a touch-screen interface for operator 16 to control what is displayed. In some embodiments, helmet display 44 may include a slewing control, keyboard, mouse, console button, or other similar type user input device for providing input. Helmet display 44 may display the field of view of the external surroundings determined by operator 16 helmet display based on line of sight operator 16 is facing or by operator 16 of control station 40. In some embodiments, helmet display 44 may be associated with a targeted object or line of sight of a weapon. In some embodiments, helmet display 44 may be configurable to display the combined digital images of the field of view from multiple different types of sensor modules 20. In some embodiments helmet display 44 may be configurable to selectively display one or more types of sensor modules 20 associated with the field of view to be displayed.

Location device 50 may be operable to determine the location information of vehicle 14. Location device 50 may comprise appropriate hardware and/or software to provide enhanced vision system 10 with location information of vehicle 14. Non-limiting examples of location device 50 may include a GPS receiver or a micro-electromechanical (MEMS) inertial navigation device. Location information of vehicle 14 may be used with lasers or ultra-wide band targeting of objects to determine the geophysical location of targeted objects.

In some embodiments, enhanced vision system 10 may use a single control station 40, such that enhanced vision system 10 is easier to use compared to the complexity of traditional systems requiring controlling separate controllers for each moving sensor array that may have their own stabilized gimbals.

Further, enhanced vision system 10 may provide a solution that is lighter in weight and consumes less power than the traditional solutions for providing an array of sensors. Traditional solutions required multiple turrets with heavy mountings and heavy armor protection that consumed a lot of power.

In some embodiments, arrays 24 may be placed around vehicle 14 with slightly overlapping fields of regard. In some embodiments, a plurality of arrays 24 may be formed into a larger array, such that processor 36 may create a digital image using the digital data stored by all of the sensor modules 20 associated with the plurality of arrays 24. In some embodiments, one or more sensor modules 20 comprising less than the total number of sensor modules 20 installed on array 24 may form a logical array as determined by processor 14 or operator 16, such that the logical array operates in a similar manner as physical arrays 24 described above.

In some embodiments, police, first responders, or border security may use enhanced vision system 10 with vehicle 14 or structure 15 to receive enhanced vision when environmental conditions cause human visual acuity to degrade. For example, border patrol may use enhanced vision system 10 to conduct stationary border surveillance to notify other sensor modules 20, vehicles, or personnel to intercept the targets attempting to cross the border. In some embodiments, physical security systems may use enhanced vision system 100 instead of only using steerable cameras for monitoring and detecting intrusions.

In some embodiments, enhanced vision system 10 may be used at a port to monitor and detect illegal shipment of weapons and any other thing or person. Enhanced vision system 200 may replace a security system that includes multiple single sensors that each have moving parts to monitor and detect other things and/or people. For example, sensor module 20 may be configurable to detect motion. Upon detecting motion, processor 36 may be configurable to store the recordings associated with the detected motion from the motion sensor. One or more tags identifying these recordings (e.g., date stamp, time, location, etc.) may be stored in a database to provide the context of these recordings and allow a user to search for these recordings.

In some embodiments, enhanced vision system 10 may provide valuable reconnaissance information. All of the recorded external surroundings of vehicle 14 or structure may be stored in memory 34 at a remote location. These recordings may be identified in a database with an indicator of when and/or where the recordings took place. For example, an image of an object or person may be searched against the recordings stored in memory 34 by enhanced vision system 10.

FIG. 2 illustrates a more detailed view of an array 24 of sensor modules 20, according to one example embodiment. In the illustrated embodiment, array 24 may include sockets configured in four rows and five columns, such that each socket may house a module sensor 20. In the illustrated embodiment, each module sensor 20 may be two inches×two inches×two inches. Each socket in array 24 can hold a module sensor 20 of two inches×two inches×two inches. Spacing between each module sensor 20 may be 0.25 inches. Thus, the walls dividing array 24 into sockets may be 0.25 inches. The illustrated array 24 may measure 13 inches wide, 9.25 inches tall, and 3 inches deep.

Array 24 may be coupled to a back plane, memory 34, and interfaces 32, which may collectively measure about an inch deep. Back plane of array 24 may be coupled to a mounting plate, which may add another one inch to the depth of array 24. Mounting plate may be wielded to vehicle 14 or structure 15. Each interface 32 may include wiring for power, data output, and control input.

In some embodiments, sensor modules 20 may be installed together for an electronically scanned array of arrays, or installed with greater separation with or without field of regard overlap. In some embodiments, sensor modules 20 may be scanned and steered electronically.

In some embodiments, a plurality of sensor modules 20 with different modes of sensing may be grouped in an array. A mode of sensing may be a band of the electromagnetic spectrum, including, but not limited to short wave infrared (SWIR), mid wave IR (MWIR), long wave IR (LWIR), radio frequency (RF), laser (which may be aligned with the most effective notches in the atmospheric interactions with a laser (e.g., 1.05 microns for eye safety), or visual spectrum and field of regard.

Thus, the array may be able to operate in at least two sensing modalities.

In some embodiments, a plurality of sensor modules 20 with the same mode of sensing may be grouped in an array. A plurality of arrays where each array may be associated with a different sensing mode may be arranged contiguously where each array's field of regard overlaps with its neighbor. Thus, enhanced vision system 10 may use two or more modalities of sensing with overlapping fields of regard. Enhanced vision system 10 is scalable in terms of sensing modalities, density of modules used for sensing, and overlap of fields of. regard to achieve a range of detection resolutions (from coarse to very high resolution) without requiring a mechanically slewed or scanned sensor head, such as a turret. Enhanced vision system 10 may be arranged by an array of arrays.

Each sensor module may have a digital signal processor 36 with interfaces 32 to memory 34 and backplane.

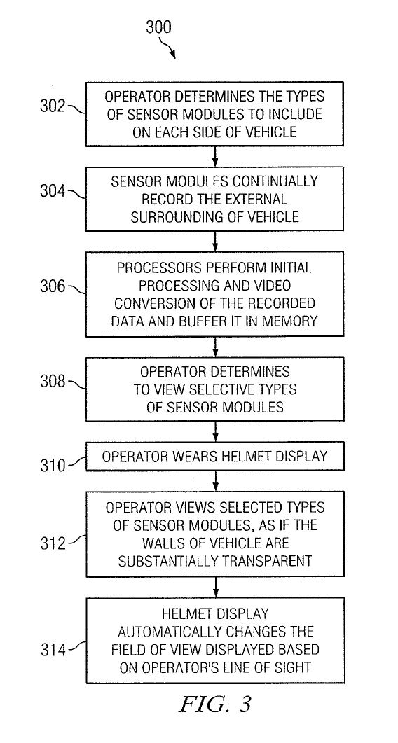

FIG. 3 provides a flow chart illustrating an example method 300 for using an array 24 of sensor modules 20, according to one example embodiment. The method begins at step 302 where operator 16 of vehicle 14 may determine the types of sensor modules 20 to include in one or more arrays 24 located on each side of vehicle 14.

At step 304, sensor modules 20 located in of arrays may continually record the external surroundings of vehicle 14 where each array 24 includes a plurality of sensor modules 20 comprising at least two different types of sensor modules 20.

At step 306, one or more processors 36 may perform initial processing and video conversion of the recorded data and buffer the processed data in memory 34. At step 308, operator 16 may selectively determine to view only sensor modules 20 of type EO, IR, and CCD camera.

At step 310, operator 16 may wear helmet display 44. At step 312, operator 16 may view the external surroundings of vehicle in a combined image of type EO, IR, and CCD camera data, as if the walls of vehicle 14 are substantially transparent.

At step 314, operator 16 may turn his or her head in any line of sight or field of view, such that helmet display 44 automatically changes, in substantially real-time, the displayed images of the external surroundings to the same line of sight or field of view where operator 16 is currently facing.

Modifications, additions, or omissions may be made to the systems and apparatuses described herein without departing from the scope of the invention. The components of the systems and apparatuses may be integrated or separated. Moreover, the operations of the systems and apparatuses may be performed by more, fewer, or other components. The methods may include more, fewer, or other steps. Additionally, steps may be performed in any suitable order. Additionally, operations of the systems and apparatuses may be performed using any suitable logic. As used in this document, “each” refers to each member of a set or each member of a subset of a set.

Although several embodiments have been illustrated and described in detail, it will be recognized that substitutions and alterations are possible without departing from the spirit and scope of the present invention, as defined by the appended claims.

To aid the Patent Office, and any readers of any patent issued on this application in interpreting the claims appended hereto, applicants wish to note that they do not intend any of the appended claims to invoke paragraph 6 of 35 U.S.C. §112 as it exists on the date of filing hereof unless the words “means for” or “step for” are explicitly used in the particular claim.

What is claimed is:

1. An enhanced vision system for a vehicle comprising:
a vehicle;
a sensor array comprising a plurality of sensor modules comprising at least two different types of sensor modules, wherein the sensor array is coupled to the exterior of the vehicle, wherein the plurality of sensor modules are configurable to record external surroundings of the vehicle;
a processor configurable to determine a field of view and one or more types of sensor modules to be displayed; and
a display located inside the vehicle, wherein the display is configurable to show the recorded external surroundings of the vehicle associated with the determined one or more types of sensor modules associated with the field of view to be displayed.

2. The enhanced vision system of claim 1, wherein the display is a helmet display configured to be worn by an operator of the vehicle.

3. The enhanced vision system of claim 1, wherein the field of view to be displayed is substantially identical to a field of view of an operator of the vehicle.

4. The enhanced vision system of claim 1, wherein the vehicle is a tank.

5. The enhanced vision system of claim 1, wherein the display is configurable to show the surroundings of the entire exterior perimeter of the vehicle.

6. The enhanced vision system of claim 1, wherein two selected sensor modules selected from the plurality of sensor modules consist of:
a) a charge coupled device (CCD) camera;
b) an electro-optical (EO) sensor;
c) an infrared radiation (IR) sensor;
d) a radio frequency (RF) sensor;
e) a laser sensor.

7. The enhanced vision system of claim 1, further comprising a plurality of sensor arrays.

8. The enhanced vision system of claim 1, wherein the external side of the plurality of sensor modules comprise a material, wherein the material is bullet proof, transparent to radio frequencies, and optically transmissive.

9. The enhanced vision system of claim 1, wherein the processor is further configurable to combine the recordings from a plurality of different types of sensor modules and the display is further configurable to show the combined recorded external surroundings from the plurality of different types of sensor modules associated with the field of view to be displayed.

10. A method for enhancing vision for a vehicle comprising:
recording external surroundings of a vehicle by a sensor array comprising a plurality of sensor modules comprising at least two different types of sensor modules, wherein the sensor array is coupled to the exterior of the vehicle;
determining a field of view to be displayed;
determining one or more types of sensor modules to be displayed; and
displaying the recorded external surroundings of the vehicle associated with the determined one or more types of sensor modules associated with the field of view to be displayed.

11. The method of claim 10, wherein the recorded external surroundings are displayed by a helmet display configured to be worn by an operator of the vehicle.

12. The method of claim 10, wherein the field of view to be displayed is substantially identical to a field of view of an operator of the vehicle.

13. The method of claim 10, wherein the vehicle is a tank.

14. The method of claim 10, wherein two selected sensor modules selected from the plurality of sensor modules consist of:
a) a charge coupled device (CCD) camera;
b) an electro-optical (EO) sensor;
c) an infrared radiation (IR) sensor;
d) a radio frequency (RF) sensor;
e) a laser sensor.

15. The method of claim 10, further comprising a plurality of sensor arrays.

16. The method of claim 10, wherein the external side of the plurality of sensor modules comprise a material, wherein the material is bullet proof, transparent to radio frequencies, and optically transmissive.

17. The method of claim 10, further comprising:
combining the recordings from a plurality of different types of sensor modules; and
displaying the combined recorded external surroundings from the plurality of different types of sensor modules associated with the field of view to be displayed.

18. An enhanced vision system for a structure comprising:
a structure;
a sensor array comprising a plurality of sensor modules comprising at least two different types of sensor modules, wherein the sensor array is coupled to the exterior of the structure, wherein the plurality of sensor modules are configurable to record external surroundings of the structure in the field of view of the sensor array, and wherein the plurality of sensor modules have no moving parts; and
a display, wherein the display is configurable to show the recorded external surroundings of the structure.

19. The enhanced vision system of claim 18, further comprising:
at least one motion sensor configurable to detect motion; and
a processor configurable to store the recordings associated with the detected motion from the motion sensor.

20. The enhanced vision system of claim 18, wherein two selected sensor modules selected from the plurality of sensor modules consist of:
a) a charge coupled device (CCD) camera;
b) an electro-optical (EO) sensor;
c) an infrared radiation (IR) sensor;
d) a radio frequency (RF) sensor;
e) a laser sensor; and
f) a motion detector sensor.
